(19) United States
(12) Patent Application Publication
(10) Pub. No.: US 2023/0383103 A1
(43) Pub. Date: Nov. 30, 2023

(54) POLYMER COMPOSITION FOR INJECTION MOLDING

(71) Applicant: Basell Poliolefine Italia S.r.l., Milan (IT)

(72) Inventors: Gianluca Musacchi, Ferrara (IT); Roberta Marchini, Ferrara (IT); Fabio Di Pietro, Ferrara (IT)

(73) Assignee: Basell Poliolefine Italia S.r.l., Milan (IT)

(21) Appl. No.: 18/032,778

(22) PCT Filed: Oct. 11, 2021
(86) PCT No.: PCT/EP2021/078019

§ 371 Date: Apr. 19, 2023

(30) Foreign Application Priority Data
Oct. 22, 2020 (EP) 20203367.6

(51) Int. Cl. C08L 23/04

(52) U.S. Cl. CPC C08L 23/04; C08L 2201/52; C08L 2207/066; C08L 2205/02

(57) ABSTRACT

A polyolefin composition made from or containing:
A) from 88% to 99% by weight of an ethylene polymer having MIP of equal to or higher than 5 g/10 min, where MIP is the melt flow index at 190° C. with a load of 5 kg, determined according to 1133-2:2011; and
B) from 1% to 12% by weight of a butene-1 polymer having MIE of equal to or higher than 800 g/10 min., where MIE is the melt flow index at 190° C. with a load of 2.16 kg, determined according to 1133-2:2011;
wherein the amounts of A) and B) are referred to the total weight of A)+B).

### FIELD OF THE INVENTION

In general, the present disclosure relates to the field of chemistry. More specifically, the present disclosure relates to polymer chemistry. In particular, the present disclosure relates to a polymer composition for injection molding.

### BACKGROUND OF THE INVENTION

In some instances, injection molding is used for producing various polymer articles. In some instances, the articles have a complex shape.

In some instances, the plastics for injection molding are polyolefins. In some instances, the polyolefins are polyethylene.

In the injection molding process, heat and pressure are applied to the polymer, thereby causing the polymer to melt and flow. The polymeric melt is injected under pressure into the mold.

Pressure is maintained on the polymeric material in the mold cavity until the polymeric material cools and solidifies. When the temperatures are reduced below the polymer's distortion temperature, the mold is opened, and the molded article is ejected.

In some instances, the molecular weight and the molecular weight distribution of polyethylene are chosen to provide melt flowability under the injection molding process conditions, without reducing the mechanical properties.

In some instances, paraffinic waxes, such as Fischer-Tropsch waxes, are used as additives, thereby improving melt flowability of polyethylene in the injection molding process.

In some instances, the waxes are added to polyethylene in amounts over about 2% by weight, thereby adversely affecting the ability to obtain a homogeneous blend and limiting any improvement in melt flowability.

In some instances, the final mechanical properties are worsened.

### SUMMARY OF THE INVENTION

In a general embodiment, the present disclosure provides a polymer composition made from or containing:
A) from 88% to 99% by weight of an ethylene polymer having MIP of equal to or higher than 5 g/10 min., where MIP is the melt flow index at 190° C. with a load of 5 kg, determined according to 1133-2:2011; and
B) from 1% to 12% by weight of a butene-1 polymer having MIE of equal to or higher than 800 g/10 min., where MIE is the melt flow index at 190° C. with a load of 2.16 kg, determined according to 1133-2:2011;
wherein the amounts of A) and B) are referred to the total weight of A)+B).

### DETAILED DESCRIPTION OF THE INVENTION

In some embodiments, the present disclosure provides a polymer composition made from or containing:
A) from 88% to 99% by weight, alternatively from 90% to 98.5% by weight, alternatively from 92% to 98.5% by weight, of an ethylene polymer having MIP of equal to or higher than 5 g/10 min., alternatively equal to or higher than 6 g/10 min., alternatively equal to or higher than 8 g/10 min., where MIP is the melt flow index at 190° C. with a load of 5 kg, determined according to 1133-2:2011; and
B) from 1% to 12% by weight, alternatively from 1.5% to 10% by weight, alternatively from 1.5% to 8% by weight, of a butene-1 polymer having MIE of equal to or higher than 800 g/10 min., alternatively equal to or higher than 1000 g/10 min., alternatively from 800 to 3000 g/10 min. alternatively from 1000 to 3000 g/10 min., where MIE is the melt flow index at 190° C. with a load of 2.16 kg, determined according to 1133-2:2011;
wherein the amounts of A) and B) are referred to the total weight of A)+B).

As used herein, the expression “ethylene polymer” includes polymers selected from the group consisting of ethylene homopolymers, ethylene copolymers containing alpha-olefin comonomers different from ethylene, and mixtures thereof. In some embodiments, the alpha-olefin comonomers have from 3 to 8 carbon atoms. In some embodiments, the comonomers are present in amounts from 1% to 10% by weight with respect to the total weight of the copolymer. In some embodiments, the alpha-olefin comonomers having from 3 to 8 carbon atoms are selected from the group consisting of propylene, butene-1, pentene-1, hexene-1, octene-1, and 4-methylpentene-1.

In some embodiments, the alpha-olefin comonomers having from 3 to 8 carbon atoms are selected from the group consisting of butene-1 and hexene-1.

As used herein, the expression “ethylene polymer” includes, as alternatives, a polymer consisting of a single component and a polymer (polymer composition) made from or containing two or more ethylene polymer components. As used herein, the expression “monomodal polymer” refers to a polymer consisting of a single component. In some embodiments, the two or more ethylene polymer have different molecular weights, thereby rendering the polymer as a “bimodal polymer” or “multimodal polymer.”

As used herein, the expression “butene-1 polymer” includes polymers selected from the group consisting of butene-1 homopolymers, copolymers of butene-1 containing alpha-olefin comonomers different from butene-1, and mixtures thereof. In some embodiments, the alpha-olefin comonomer is selected from the group consisting of ethylene, propylene, and alpha-olefins having from 5 to 10 carbon atoms.

In some embodiments, the alpha-olefin comonomer is ethylene.

In some embodiments, the alpha-olefins having from 5 to 10 carbon atoms are selected from the group consisting of hexene-1 and octene-1.

As used herein, the expression “butene-1 polymer” includes, as alternatives, a polymer consisting of a single component and a polymer (polymer composition) made from or containing two or more butene-1 polymer components. In some embodiments, the butene-1 polymer components have different amounts of comonomers.

In some embodiments, the amounts of A) and B) are:
from 88% to 97% by weight of A) and from 3% to 12% by weight of B), alternatively
from 90% to 97% by weight of A) and from 3% to 10% by weight of B), alternatively
from 92% to 97% by weight of A) and from 3% to 8% by weight of B);
wherein the amounts of A) and B) are referred to the total weight of A)+B).

In some embodiments, the density for the ethylene polymer A) is from 0.930 to 0.970 g/cm³, alternatively from 0.940 to 0.965 g/cm³, measured according to ISO 1183-1:2012 at 23° C.

In some embodiments, the MIP for the ethylene polymer A) is:
from 5 to 20 g/10 min., alternatively
from 5 to 15 g/10 min., alternatively
from 6 to 20 g/10 min., alternatively
from 6 to 15 g/10 min., alternatively
from 8 to 20 g/10 min., alternatively
from 8 to 15 g/10 min.

In some embodiments, the ethylene polymer A) has an additional feature selected from the group consisting of:
a MIF value from 50 to 200 g/10 min., alternatively from 50 to 150 g/10 min., alternatively from 60 to 200 g/10 min., alternatively from 60 to 150 g/10 min., alternatively from 80 to 200 g/10 min., alternatively from 80 to 150 g/10 min., where MIF is the melt flow index at 190° C. with a load of 21.60 kg, determined according to ISO 1133-2:2011;
a MIE value from 1 to 10 g/10 min., alternatively from 1 to 8 g/10 min., alternatively from 2 to 10 g/10 min., alternatively from 2 to 8 g/10 min.;
a ratio MIF/MIP of equal to or higher than 5, alternatively from 5 to 20, alternatively from 5 to 15;
and
a ratio MIF/MIE of equal to or higher than 20, alternatively from 20 to 40, alternatively from 20 to 35.

In some embodiments, the ethylene polymer A) is a homopolymer or copolymer prepared by polymerization processes in the presence of coordination catalysts.

In some embodiments, the polymerization process is carried out in the presence of a Ziegler-Natta catalyst.

In some embodiments, the Ziegler-Natta polymerization catalysts are made from or containing the reaction product of an organic compound of a metal of Groups I-III of the Periodic Table and an inorganic compound of a transition metal of Groups IV-VIII of the Periodic Table. In some embodiments, the organic compound is an aluminum alkyl. In some embodiments, the inorganic compound is titanium halide. In some embodiments, the reaction product is supported on a Mg halide.

In some embodiments, the polymerization is carried out in a single step, thereby preparing a monomodal ethylene polymer. In some embodiments, the polymerization is carried out in two or more steps under different polymerization conditions, thereby preparing a multimodal ethylene polymer.

In some embodiments, the butene-1 polymer B) has a Brookfield viscosity at 190° C. from 1500 to 20000 mPa·sec, alternatively from 2000 to 15000 mPa·sec, alternatively from 2500 to 10000 mPa·sec.

In some embodiments, the butene-1 polymer B) is a copolymer having a copolymerized comonomer content, alternatively a copolymerized ethylene content. In some embodiments, the comonomer content is from 0.5% to 4.0% by mole, alternatively from 0.7% to 3.5% by mole.

In some embodiments, the butene-1 polymer B) is a butene-1 copolymer composition made from or containing:
B1) a butene-1 homopolymer or a copolymer of butene-1 with a comonomer selected from the group consisting of ethylene, propylene, alpha-olefins having from 5 to 10 carbon atoms, and mixtures thereof, having a copolymerized comonomer content (C_{A1}) of up to 2% by mole; and
B2) a copolymer of butene-1 with a comonomer selected from the group consisting of ethylene, propylene, alpha-olefins having from 5 to 10 carbon atoms, and mixtures thereof, having a copolymerized comonomer content (C_{A2}) of from 3 to 5% by mole;
wherein the composition has a total copolymerized comonomer content of 0.5-4.0% by mole, alternatively of from 0.7 to 3.5% by mole, referred to the sum of B1)+B2).

In some embodiments, the relative amounts of B1) and B2) range from 10% to 40% by weight, alternatively from 15% to 35% by weight, of B1) and from 90% to 60% by weight, alternatively from 85% to 65% by weight, of B2), wherein the amounts being referred to the sum of B1)+B2).

In some embodiments, the MIP values for the butene-1 polymer B) are equal to or higher than 1800 g/10 min., alternatively from 1800 to 3000 g/10 min.

In some embodiments, the butene-1 polymer B) has an additional feature selected from the group consisting of:
a) a molecular weight distribution (Mw/Mn) lower than 4, alternatively lower than 3; alternatively lower than 2.5;
b) a melting point (TmII) lower than 110° C., alternatively lower than 100° C., alternatively lower than c) a melting point (TmII) higher than 80° C.;
d) a glass transition temperature (Tg) in the range from −40° C. to −10° C., alternatively from −30° C. to −10° C.;
e) isotactic pentads (mmmm) measured with ¹³C-NMR operating at 150.91 MHz higher than 90%; alternatively higher than 93%, alternatively higher than 95%;
f) 4.1 insertions not detectable using a ¹³C-NMR operating at 150.91 MHz; and
g) X-ray crystallinity of from 25 to 65%.
   In some embodiments, the molecular weight distribution (Mw/Mn) is lower than 4, alternatively lower than 3; alternatively lower than 2.5, and has a lower limit of 1.5.

In some embodiments, the butene-1 polymer B) has a further additional feature selected from the group consisting of:
i) an intrinsic viscosity (IV) measured in tetrahydronaphtalene (THN) at 135° C. equal to or lower than 0.6 dl/g, alternatively between 0.2 and 0.6 dl/g;
ii) Mw equal to or greater than 30.000 g/mol, alternatively from 30.000 to 100.000 g/mol; and
iii) a density of 0.885-0.925 g/cm³, alternatively of 0.890-0.920 g/cm³.

In some embodiments, the butene-1 polymer B) is obtained by polymerizing the monomer(s) in the presence of a metallocene catalyst system obtainable by contacting:
a stereorigid metallocene compound;
an alumoxane or a compound capable of forming an alkyl metallocene cation; and, optionally,
an organo aluminum compound.

In some embodiments, the stereorigid metallocene compound has the following formula (I):

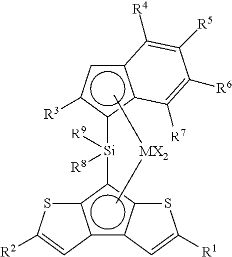

wherein:
M is an atom of a transition metal selected from those belonging to group 4; alternatively M is zirconium;
X, equal to or different from each other, is a hydrogen atom, a halogen atom, a R, OR, OR′O, OSO₂CF₃, OCOR, SR, NR₂ or PR₂ group wherein R is a linear or branched, saturated or unsaturated C₁-C₂₀-alkyl, C₃-C₂₀-cycloalkyl, C₆-Cao-aryl, C₇-C₂₀-alkylaryl or C₇-C₂₀-arylalkyl radical, optionally containing heteroatoms belonging to groups 13-17 of the Periodic Table of the Elements; and R′ is a C₁-C₂₀-alkylidene, C₆-C₂₀-arylidene, C₇-C₂₀-alkylarylidene, or C₇-C₂₀-arylalkylidene radical;
R¹, R², R⁵, R⁶, R⁷, R⁸ and R⁹, equal to or different from each other, are hydrogen atoms, or linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radicals, optionally containing heteroatoms belonging to groups 13-17 of the Periodic Table of the Elements, providing R⁶ or R⁷ is a linear or branched, saturated or unsaturated C₁-C₂₀-alkyl radical, optionally containing heteroatoms belonging to groups 13-17 of the Periodic Table of the Elements;
R³ and R⁴, equal to or different from each other, are linear or branched, saturated or unsaturated C₁-C₂₀-alkyl radicals, optionally containing heteroatoms belonging to groups 13-17 of the Periodic Table of the Elements.
   In some embodiments, X is a hydrogen atom, a halogen atom, a OR′O or R group. In some embodiments, X is chlorine or a methyl radical. In some embodiments, R⁵ and R⁶, or R⁸ and R⁹ form a saturated or unsaturated, 5 or 6 membered rings. In some embodiments, the ring bears C₁-C₂₀ alkyl radicals as substituents. In some embodiments, R¹, R², R⁵, R⁶, R⁷, R⁸, or R⁹ is a C₁-C₁₀-alkyl radical. In some embodiments, R³ and R⁴ equal to or different from each other are C₁-C₁₀-alkyl radicals; alternatively R³ is a methyl, or ethyl radical; and R⁴ is a methyl, ethyl, or isopropyl radical.

In some embodiments, the compounds of formula (I) have formula (Ia):

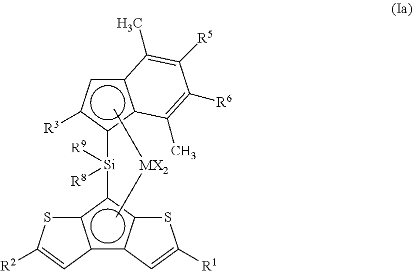

wherein:
M, X, R¹, R², R⁵, R⁶, R⁸ and R⁹ are as described above;
R³ is a linear or branched, saturated or unsaturated C₁-C₂₀-alkyl radical, optionally containing heteroatoms belonging to groups 13-17 of the Periodic Table of the Elements; alternatively R³ is a C₁-C₁₀-alkyl radical; alternatively R³ is a methyl, or ethyl radical.

In some embodiments, the metallocene compounds are selected from the group consisting of dimethylsilyl{(2,4,7-trimethyl-1-indenyl)-7-(2,5-dimethyl-cyclopenta[1,2-b:4,3-b′]-dithiophene)} zirconium dichloride; dimethylsilanediyl{(1-(2,4,7-trimethylindenyl)-7-(2,5-dimethyl-cyclopenta[1,2-b:4,3-b′]-dithiophene)}Zirconium dichloride, and dimethylsilanediyl{(1-(2,4,7-trimethylindenyl)-7-(2,5-dimethyl-cyclopenta[1,2-b:4,3-b′]-dithiophene)}zirconium dimethyl.

In some embodiments, the alumoxanes are selected from the group consisting of methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO), and tetra-(2,3,3-trimethylbutyl)alumoxane (TTMBAO).

In some embodiments, the alkylmetallocene cation is prepared from compounds of formula D⁺E⁻, wherein D⁺ is a Brønsted acid, which can donate a proton and react irreversibly with a substituent X of the metallocene of formula (I), and E⁻ is a compatible anion, which can stabilize the active catalytic species originating from the reaction of the two compounds, and removable by an olefinic monomer. In some embodiments, the anion E⁻ is made from or containing one or more boron atoms.

In some embodiments, the organo aluminum compound are selected from the group consisting of trimethylaluminum (TMA), triisobutylaluminum (TIBA), tris(2,4,4-trimethyl-pentyl)aluminum (TIOA), tris(2,3-dimethylbutyl)aluminum (TDMBA), and tris(2,3,3-trimethylbutyl)aluminum (TTMBA).

In some embodiments, the catalyst system and the polymerization processes employing such catalyst system are as disclosed in Patent Cooperation Treaty Publication Nos. WO2004099269 and WO2009000637.

In some embodiments, the polymerization process is carried out with the catalysts by operating in liquid phase, optionally in the presence of an inert hydrocarbon solvent, or in gas phase, using fluidized bed or mechanically agitated gas phase reactors.

In some embodiments, the hydrocarbon solvent is aromatic or aliphatic. In some embodiments, the aromatic solvent is toluene. In some embodiments, the aliphatic solvent is selected from the group consisting of propane, hexane, heptane, isobutane, cyclohexane, 2,2,4-trimethylpentane, and isododecane.

In some embodiments, the polymerization process is carried out by using liquid butene-1 as the polymerization medium. In some embodiments, the polymerization temperature is from 20° C. to 150° C., alternatively between 50° C. and 90° C., alternatively from 65° C. to 82° C.

In some embodiments, the concentration of hydrogen in the liquid phase, during the polymerization reaction, (molar ppm H₂/butene-1 monomer) is from 1800 ppm to 6000 ppm, alternatively from 1900 ppm to 5500 ppm.

In some embodiments, the butene-1 polymer is made from or containing components B1) and B2), which are prepared separately and blended in the molten state. In some embodiments, blending in the molten state is achieved with mono- or twin-screw extruders.

In some embodiments, the butene-1 polymer, which is made from or containing components B1) and B2), is prepared directly in polymerization.

In some embodiments, the polymerization process includes at least two sequential stages, carried out in two or more reactors connected in series, wherein components B1) and B2) are prepared in separate subsequent stages, operating in each stage, except for the first stage, in the presence of the polymer formed and the catalyst used in the preceding stage.

In some embodiments, the catalyst is added in the first reactor, or in more than one reactor.

In some embodiments, the butene-1 polymers B) having MIE of equal to or higher than 800 g/10 min. are as disclosed in Patent Cooperation Treaty Publication Nos. WO2006045687, WO2018007279, WO2018007280, WO2020016143, and WO2020016144.

In some embodiments, the polymer composition is prepared by melting and blending the components. In some embodiments, the blending is effected in a blending apparatus at temperatures of from 180 to 310° C., alternatively from 190 to 280° C., alternatively from 200 to 250° C.

In some embodiments, the melt-blending apparatuses are extruders or kneaders, alternatively twin-screw extruders. In some embodiments, the components are premixed at room temperature in a mixing apparatus.

In some embodiments, the polymer composition in the form of the premixed components is fed directly to the processing equipment used to prepare the final article, thereby omitting a previous melt blending step.

In some embodiments, the polymer composition is further made from or containing additives. In some embodiments, the additives are selected from the group consisting of stabilizing agents (against heat, light, U.V.), plasticizers, antiacids, antistatic, water repellant agents, and pigments.

In some embodiments, the polymer composition has a property selected from the group consisting of:
a Charpy at 23° C. of from 5 to 70 kJ/m²;
a Charpy at 0° C. of from 4 to 50 kJ/m²; and
a Charpy at −20° C. of from 2 to 40 kJ/m²;
wherein the Charpy values are measured according to ISO 179/1eA, 48 hours after molding.

In some embodiments, the polymer composition has a flexural modulus lower than the flexural modulus of component A).

In some embodiments, the polymer composition has a flexural modulus of from 500 to 1000 MPa, alternatively from 500 to 900 MPa, measured according to norm ISO 178:2019, 48 hours after molding.

In some embodiments, the polymer composition is processed on injection molding machines. In some embodiments, the finish on the articles obtained is homogeneous. In some embodiments, the finish of the articles is improved by increasing the rate of injection or raising the mold temperature.

In some embodiments, the polymer composition is used for preparing extruded articles, alternatively for prepared extruded cable covering.

In some embodiments, the present disclosure provides an injection-molded or extruded article made from or containing the polymer composition.

### Examples

Various embodiments, compositions, and methods as provided herein are disclosed below in the following examples. These examples are illustrative and not intended to limit the scope of the disclosure.

The following analytical methods are used to characterize the polymer compositions.

MIF, MIE, and MIP

Determined according to norm ISO 1133-2:2011 at 190° C. with the specified load.

Density

Measured according to ISO 1183-1:2012 at 23° C.

Brookfield Viscosity

Measured at 190° C. by a Cylindrical Spindle Rotational Viscometer HA Ametek/Benelux Scientific model DV2T, equipped with a drive motor capable of variable testing speed and a set of spindles capable of achieving and maintaining a torque at about 80%.

The spindle/chamber combination was SC4-27/SC4-13R/RP.

During the test, the sample was subjected to a stepwise rotation increase until a torque value of around 80% was reached and maintained. Rotation started at 10 RPM then increased stepwise by 2 RPM per 5 seconds.

The Brookfield viscosity, expressed in mPa*s, was calculated as Shear Stress (mPa)/Shear Rate (sec-1) ratio and determined by averaging the results obtained during the last 20 minutes of acquisition (1 datapoint/minute).

Intrinsic Viscosity (IV)

Determined according to norm ASTM D 2857 in tetrahydronaphthalene at 135° C.

Comonomer Contents

Component A)

The comonomer content was determined by IR in accordance with ASTM D 6248 98, using an FT-IR spectrometer Tensor 27 from Bruker.

Component B)

Comonomer contents were determined via FT-IR.

The spectrum of a pressed film of the polymer was recorded in absorbance vs. wavenumbers (cm⁻¹). The following measurements were used to calculate the ethylene content:
a) area (Aₜ) of the combination absorption bands between 4482 and 3950 cm⁻¹, which was used for spectrometric normalization of film thickness;
b) factor of subtraction (FCR_{C2}) of the digital subtraction between the spectrum of the polymer sample and the absorption band due to the sequences BEE and BEB (B: 1, butene units, E: ethylene units) of the methylenic groups (CH₂ rocking vibration); and
c) Area (A_{C2,block}) of the residual band after subtraction of the C₂PB spectrum, which comes from the sequences EEE of the methylenic groups (CH₂ rocking vibration).

Apparatus

A Fourier Transform Infrared spectrometer (FTIR) was used.

A hydraulic press with platens heatable to 200° C. (Carver or equivalent) was used.

Method

Calibration of (BEB+BEE) Sequences

A calibration straight line was obtained by plotting % (BEB+BEE) wt vs. FCR_{C2}/Aₜ. The slope Gr and the intercept Ir were calculated from a linear regression.

Calibration of EEE Sequences

A calibration straight line was obtained by plotting % (EEE) wt vs. A_{C2,block}/Aₜ. The slope G_{H} and the intercept I_{H} were calculated from a linear regression.

Sample Preparation

Using a hydraulic press, a thick sheet was obtained by pressing about 1.5 g of sample between two aluminum foils. If homogeneity was uncertain, a minimum of two pressing operations occurred. A small portion was cut from this sheet to mold a film. The film thickness was between 0.1-0.3 mm.

The pressing temperature was 140±10° C.

It is believed that a crystalline phase modification takes place with time. As such, the IR spectrum of the sample film was collected as soon as the sample was molded.

Procedure

The instrument data acquisition parameters were as follows:
Purge time: 30 seconds minimum.
Collect time: 3 minutes minimum.
Apodization: Happ-Genzel.
Resolution: 2 cm⁻¹.
The IR spectrum of the sample was collected vs. an air background.

Calculation

The concentration was calculated by weight of the BEE+BEB sequences of ethylene units:

$$\% ( BEE + BEB ) wt = {G}_{r} \cdot \frac{{FCR}_{C 2}}{{A}_{t}} + {I}_{r}$$

The residual area (AC2,block) was calculated after the subtraction described above, using a baseline between the shoulders of the residual band.

The concentration was calculated by weight of the EEE sequences of ethylene units:

$$\% ( EEE ) wt = {G}_{H} \cdot \frac{{A}_{C 2 , block}}{{A}_{t}} + {I}_{H}$$

The total amount of ethylene percent by weight was calculated:

% C2 wt=[%(BEE+BEB) wt+%(EEE) wt]

Thermal Properties (Melting Temperatures and Enthalpies)

Determined by Differential Scanning Calorimetry (D.S.C.) on a Perkin Elmer DSC-7 instrument.
For the determination of TmII (the melting temperature measured in the second heating run), a weighed sample (5-10 mg) obtained from the polymerization was sealed into an aluminum pan and heated at 200° C. with a scanning speed corresponding to 10° C./minute. The sample was kept at 200° C. for 5 minutes, thereby allowing melting of the crystallites and cancelling the thermal history of the sample. Successively, after cooling to −20° C. with a scanning speed corresponding to 10° C./minute, the peak temperature was taken as the crystallization temperature (Tc). After standing for 5 minutes at −20° C., the sample was heated for a second time at 200° C. with a scanning speed corresponding to ° C./min. In this second heating run, the peak temperature measured was taken as (TmII). If more than one peak was present, the highest (most intense) peak was taken as TmII. The area under the peak (or peaks) was taken as global melting enthalpy (DH TmII).
The melting enthalpy and the melting temperature were also measured after aging (without cancelling the thermal history) as follows by using Differential Scanning Calorimetry (D.S.C.) on a Perkin Elmer DSC-7 instrument. A weighed sample (5-10 mg) obtained from the polymerization was sealed into an aluminum pan and heated at 200° C. with a scanning speed corresponding to ° C./minute. The sample was kept at 200° C. for 5 minutes, thereby allowing melting of the crystallites. The sample was then stored for 10 days at room temperature. After 10 days, the sample was subjected to DSC, cooled to −20° C., and then heated at 200° C. with a scanning speed corresponding to 10° C./min. In this heating run, the peak temperature was taken as the melting temperature (TmI). If more than one peak was present, the highest (most intense) peak was taken as TmI. The area under the peak (or peaks) was taken as global melting enthalpy after 10 days (DH TmI).

NMR Analysis of Chain Structure

¹³C NMR spectra were acquired on a Bruker AV-600 spectrometer equipped with cryo-probe, operating at 150.91 MHz in the Fourier transform mode at 120° C.

The peak of the T_{βδ} carbon (nomenclature according to C. J. Carman, R. A. Harrington and C. E. Wilkes, Macromolecules, 10, 3, 536 (1977)) was used as an internal reference at 37.24 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-¹³C coupling. About 512 transients were stored in 32K data points using a spectral window of 9000 Hz.

The assignments of the spectra, the evaluation of triad distribution and the composition were made according to Kakugo [M. Kakugo, Y. Naito, K. Mizunuma and T. Miyatake, Macromolecules, 16, 4, 1160 (1982)] and Randall [J. C. Randall, Macromol. Chem Phys., C30, 211 (1989)] using the following:
BBB=100 (T_{ββ})/S=I5
BBE=100T_{βδ}/S=I4
EBE=100 P_{δδ}/S=I14
BEB=100 S_{ββ}/S=I13
BEE=100 S_{αδ}/S=I7
EEE=100(0.25 S_{γδ}+0.5 S_{δδ})/S=0.25 I9+0.5I10

| Area | Chemical Shift | Assignments | Sequence |
|---|---|---|---|
| 1 | 40.40-40.14 | Sαα | BBBB |
| | 39.64 | Tδδ | EBE |
| 2 | 39-76-39.52 | Sαα | BBBE |
| 3 | 39.09 | Sαα | EBBE |
| 4 | 37.27 | Tβδ | BBE |
| 5 | 35.20-34.88 | Tββ | BBB |
| 6 | 34.88-34.49 | Sαγ | BBEB + BEBE |
| 7 | 34.49-34.00 | Sαδ | EBEE + BBEE |
| 8 | 30.91 | Sγγ | BEEB |
| 9 | 30.42 | Sγδ | BEEE |
| 10 | 29.90 | Sδδ | EEE |
| 11 | 27.73-26.84 | Sβδ + 2B₂ | BBB + BBE |
| | | | EBEE + BBEE |
| 12 | 26.70 | 2B₂ | EBE |
| 13 | 24.54-24.24 | Sββ | BEB |
| 14 | 11.22 | Pδδ | EBE |
| 15 | 11.05 | Pβδ | BBE |
| 16 | 10.81 | Pββ | BBB |

To a first approximation, the mmmm was calculated using 2B2 carbons as follows:

| Area | Chemical shift | assignments |
|---|---|---|
| B1 | 28.2-27.45 | mmmm |
| B2 | 27.45-26.30 | |

mmmm=B₁*100/(B₁+B₂−2*A₄−A₇−A₁₄)

Molecular Weights Determination by GPC

Measured by Gel Permeation Chromatography (GPC) in 1,2,4-trichlorobenzene (TCB). Molecular weight parameters (Mn, Mw) and molecular weight distributions Mw/Mn for the samples were measured using a GPC-IR apparatus by PolymerChar, which was equipped with a column set of four PLgel Olexis mixed-bed (Polymer Laboratories) and an IR5 infrared detector (PolymerChar). The dimensions of the columns were 300×7.5 mm and the particle size was 13 μm. The mobile phase flow rate was kept at 1.0 mL/min. The measurements were carried out at 150° C. Solution concentrations were 2.0 mg/mL (at 150° C.), and 0.3 g/L of 2,6-diterbutyl-p-cresol were added to prevent degradation. For GPC calculation, a universal calibration curve was obtained using 12 polystyrene (PS) reference samples supplied by PolymerChar (peak molecular weights ranging from 266 to 1220000). A third-order polynomial fit was used to interpolate the experimental data and obtain the calibration curve. Data acquisition and processing were done using Empower 3 (Waters). The Mark-Houwink relationship was used to determine the molecular weight distribution and the average molecular weights: the K values were K_{PS}=1.21×10⁻⁴ dL/g and K_{PB}=1.78×10⁻⁴ dL/g for PS and polybutene (PB) respectively, while the Mark-Houwink exponents α=0.706 for PS and α=0.725 for PB were used.

For butene/ethylene copolymers, the composition of each sample was assumed constant in the range of molecular weight and the K value of the Mark-Houwink relationship was calculated using a linear combination as reported below:

K_{EB}=x_{E}K_{PE}+x_{B}K_{PB}

where K_{EB} was the constant of the copolymer, K_{PE} (4.06×10⁻⁴, dL/g) and K_{PB} (1.78×10⁻⁴ dL/g) were the constants of polyethylene (PE) and PB, x_{E} and x_{B} were the ethylene and the butene weight relative amounts with x_{E}+x_{B}=1. The Mark-Houwink exponents α=0.725 was used for the butene/ethylene copolymers independently of composition. End processing data treatment was fixed for the samples, thereby including fractions up at 1000 in terms of molecular weight equivalent. Fractions below 1000 were investigated via GC.

Determination of X-Ray Crystallinity

The X-ray crystallinity was measured with an X-ray Diffraction Powder Diffractometer (XDPD) that uses the Cu-Kα1 radiation with fixed slits and collects spectra between diffraction angle 2Θ=5° and 2Θ=35° with step of 0.1° per 6 seconds.

The samples were diskettes of about 1.5-2.5 mm of thickness and 2.5-4.0 cm of diameter made by compression molding. The diskettes were aged at room temperature (23° C.) for 96 hours.

After this preparation, the specimen was inserted in the XDPD sample holder. The XRPD instrument was set to collect the XRPD spectrum of the sample from diffraction angle 2Θ=5° to 2Θ=35° with steps of 0.1° by using counting time of 6 seconds. Aₜ the end, the final spectrum was collected.

Ta was defined as the total area between the spectrum profile and the baseline, expressed in counts/sec·2Θ. Aa was defined as the total amorphous area, expressed in counts/sec·2Θ. Ca was defined as the total crystalline area, expressed in counts/sec·2Θ.

The spectrum or diffraction pattern was analyzed in the following steps:
1) define a linear baseline for the whole spectrum and calculate the total area (Ta) between the spectrum profile and the baseline;
2) define an amorphous profile, along the whole spectrum, that separates the amorphous regions from the crystalline regions according to the two-phase model;
3) calculate the amorphous area (Aa) as the area between the amorphous profile and the baseline; 4) calculate the crystalline area (Ca) as the area between the spectrum profile and the amorphous profile as Ca=Ta−Aa; and
5) calculate the degree of crystallinity (% Cr) of the sample using the formula:

% Cr=100×Ca/Ta.

Glass transition temperature via DMTA (Dynamic Mechanical Thermal Analysis) Molded specimens of 76 mm by 13 mm by 1 mm were fixed to a DMTA machine for tensile stress. The frequency of the tension and relies of the sample was fixed at 1 Hz. The DMTA translated the elastic response of the specimen starting from −100° C. to 130° C. The elastic response was plotted versus temperature. The elastic modulus for a viscoelastic material was defined as E=E′+iE″. In some instances, the DMTA split the two components E′ and E″ by resonance and plotted E′ vs temperature and E′/E″=tan (δ) vs temperature.

The glass transition temperature Tg was assumed to be the temperature at the maximum of the curve E′/E″=tan (δ) vs temperature.

Charpy Impact Strength

According to ISO 179/1eA at 23° C., 0° C. and −20° C., measured 48 hours after molding.

Flexural Modulus

According to norm ISO 178:2019, measured 48 hours after molding.

Spiral Flow Test (Spiral Length)

The spiral flow test was carried out on a Ripress FL 170 HES apparatus equipped with a spiral mold having spiral thickness of 2.5 mm.

The tested polymer was injected into the cavity of the spiral mold through a 3 mm die, under the following conditions:
a stock temperature of 230° C.;
shot step excluded by setting injection by position=0.1 mm;
a hydraulic holding pressure from 29 to 126 bar equivalent to a pressure on polymer material from 300 to 1220 bar;
a screw diameter 50 mm;
a mold temperature of 40° C.; and
a closing pressure of 170 t.

The spiral length was the length of the solid polymer spiral extracted from the spiral mold after cooling.

### Examples 1-6 and Comparative Examples 1-4

Ethylene Polymer A)

High density polyethylene, having density of 0.955 g/cm³, MIP of 11.0 g/10 min., MIF of 105 g/10 min. and MIE of 4 g/10 min., was commercially available from LyondellBasell under the trademark Hostalen GD 7255 LS.

Butene-1 Polymer B)

Butene-1 polymer B)-I and butene-1 polymer B)-II were used.

Butene-1 Polymer B)-I

Preparation of the Catalytic Solution

Under nitrogen atmosphere, 6400 g of a 33 g/L solution of triisobutylaluminum (TIBA) in isododecane and 567 g of 30% wt/wt solution of methylalumoxane (MAO) in toluene were loaded in a 20 L jacketed glass reactor, stirred by an anchor stirrer, and reacted at room temperature for about 1 hour under stirring.

Next, 1.27 g of metallocene dimethylsilyl{(2,4,7-trimethyl-1-indenyl)-7-(2,5-dimethyl-cyclopenta[1,2-b:4,3-b′]-dithiophene)} zirconium dichloride, prepared according to Example 32 of Patent Cooperation Treaty Publication No. WO0147939, was added and dissolved under stirring for about 30 minutes.

The final solution was discharged from the reactor into a cylinder through a filter, thereby removing eventual solid residues.

The resulting composition of the solution was:

| Al | Zr | Al/Zr | metallocene |
|---|---|---|---|
| (wt. %) | (wt. %) | (mol ratio) | conc. (mg/l) |
| 1.72 | 0.0029 | 2001 | 137 |

Polymerization

The polymerization was carried out in two stirred reactors operated in series, wherein liquid butene-1 constituted the liquid medium. The catalyst solution was fed in both reactors. The polymerization conditions are reported in Table 1. The butene-1/ethylene copolymer was recovered as melt from the solution and cut in pellets. Properties of the copolymer are reported in Table 2.

TABLE 1

| First Reactor | | |
|---|---|---|
| Temperature | | 75 |
| H₂ in liquid phase | molar ppm | 3248 |
| C₂₋ in liquid phase | wt. % | 0.3 |
| Mileage | Kg/gMe | 1485 |
| Split | wt. % | 60 |
| C₂₋ content | wt. % | 1 |
| C₂₋ content | mole % | 1.98 |
| Second Reactor | | |
| Temperature | ° C. | 75 |
| H₂ in liquid phase | molar ppm | 3248 |
| C₂₋ in liquid phase | wt. % | 0.4 |
| Split | wt. % | 40 |
| C₂₋ content | wt. % | 1 |
| C₂₋ content | mole % | 1.98 |
| Total mileage | Kg/gMe | 1539 |
| Total C₂₋ content | wt. % | 1.0 |
| Total C₂₋ content | mole % | 1.98 |

Note:
C₂₋ = ethylene; kg/gMe = kilograms of polymer per gram of metallocene; Split = amount of polymer produced in the concerned reactor.

TABLE 2

| | | |
|---|---|---|
| MFR (190° C./2.16 Kg) | g/10 min. | 1200 |
| Intrinsic viscosity (IV) | dl/g | 0.4 |
| Mw/Mn | | 2.1 |
| TmII | | 81.9 |
| TmI | ° C. | 103 |
| Tg | ° C. | −13 |
| Brookfield Viscosity | mPa · s | 6900 |
| (180° C.) | | |
| Crystallinity (X-ray) | % | 58 |
| Density | g/cm³ | 0.9090 |
| Flexural modulus | MPa | 350 |

Butene-1 Polymer B)-II

Using the catalytic solution and polymerization equipment, which were used for the preparation of the butene-1 polymer B)-I, the polymerization was carried out in two stirred reactors operated in series, wherein liquid butene-1 constituted the liquid medium. The catalyst solution was injected in both reactors. The polymerization was carried out in continuous at a polymerization temperature of 75° C. The residence time in each reactor was in a range of 120÷200 min. The concentration of hydrogen during polymerization was 4900 ppm mol H₂/(C₄₋) bulk, where C₄₋=butene-1. The comonomer was fed to the reactors in an amount of C₂₋/C₄₋ 0.35% wt. The ethylene comonomer was copolymerized (C₂₋ “stoichiometric” feed to the reactor). The catalyst yield (mileage) was of 2000 kg/g metallocene active component. The butene-1 copolymer was recovered as melt from the solution and cut in pellets. Properties of the copolymer are reported in Table 3.

TABLE 3

| | | |
|---|---|---|
| MFR | g/10 min. | 2500 |
| C₂₋ (IR) | wt. % | 1.1 |
| IV | dl/g | 0.34 |
| Mw/Mn | | 2.1 |
| TmII | ° C. | 83.5 |
| TmI | | 103 |
| Tg | ° C. | −13 |
| Brookfield Viscosity | mPa · s | 3200 |
| (180° C.) | | |
| Crystallinity (X-ray) | % | 55 |
| Density | g/cm³ | 0.912 |
| Flexural Modulus | MPa | 300-350 |

Wax (Comparative)

Fischer-Tropsch wax, having Drop melting point (measured according to ASTM D 3954) of 116° C., Penetration at 25° C. (measured according to ASTM D 1321) of 0.1 mm and Brookfield viscosity at 135° C. (measured according to method Sasol Wax 011) of 12 cP, was commercially available from Sasol under the trademark EnHance FG.

Preparation of the Polymer Compositions

### Examples 1-6

The butene-1 polymers B)-I and B)-II were blended with the ethylene polymer A) in the amounts reported in Table 4. The final properties of the resulting polymer compositions are also reported in Table 4.

### Comparative Examples 1-4

In Table 5, Comparative Example 1 reports the properties of ethylene polymer A) in pure state.

In Comparative Examples 2-4, the Fischer-Tropsch wax was blended with ethylene polymer A) in the amounts reported in Table 5. The final properties of the resulting polymer compositions are also reported in Table 5.

The amounts reported in Tables 4 and 5 are expressed in weight percent with respect to the total weight of the polymer composition.

The compositions of Examples 1-6 and Comparative Examples 2-4 were prepared by dry-mixing off-line the components and feeding the mixtures in the hopper of the injection molding equipment for the spiral flow test.

The melt-blending step occurred in the injection molding equipment.

TABLE 4

| | | Ex. 1 | Ex. 2 | Ex. 3 | Ex. 4 | Ex. 5 | Ex. 6 |
|---|---|---|---|---|---|---|---|
| B) - I | wt. % | 2% | 4% | 6% | — | — | — |
| B) - II | wt. % | — | — | — | 2% | 4% | 6% |
| Spiral Length at | mm | 160 | 200 | 260 | 170 | 220 | 300 |
| 300 bar | | | | | | | |
| Spiral Length at | mm | 290 | 350 | 410 | 310 | 395 | 500 |
| 500 bar | | | | | | | |
| Spiral Length at | mm | 405 | 480 | 545 | 410 | 590 | 660 |
| 720 bar | | | | | | | |
| Spiral Length at | mm | 520 | 610 | 770 | 540 | 660 | 820 |
| 1000 bar | | | | | | | |
| Spiral Length at | mm | 650 | 720 | 915 | 660 | 730 | 1080 |
| 1220 bar | | | | | | | |
| Charpy at 23° C. | kJ/m² | 9.5 | 16 | 42.8 | 9 | 28.1 | 45.5 |
| Charpy at 0° C. | kJ/m² | 8.6 | 12.6 | 40.5 | 9.9 | 13.3 | 28.6 |
| Charpy at −20° C. | kJ/m² | 5.2 | 11.7 | 23.5 | 6.7 | 12.8 | 17.2 |
| Flexural Modulus | MPa | 870 | 845 | 830 | 870 | 840 | 800 |

TABLE 5

| | | Comp. | Comp. | Comp. | Comp. |
|---|---|---|---|---|---|
| | | 1 | 2 | 3 | 4 |
| Wax | wt. % | — | 2% | 4% | 6% |
| Spiral Length at | mm | 160 | 160 | 170 | 180 |
| 300 bar | | | | | |
| Spiral Length at | mm | 280 | 290 | 300 | 310 |
| 500 bar | | | | | |
| Spiral Length at | mm | 380 | 400 | 410 | 420 |
| 720 bar | | | | | |
| Spiral Length at | mm | 510 | 530 | 540 | 550 |
| 1000 bar | | | | | |
| Spiral Length at | mm | 620 | 650 | 660 | 680 |
| 1220 bar | | | | | |
| Charpy at 23° C. | kJ/m² | 8.1 | 7 | 6.3 | 6.4 |
| Charpy at 0° C. | kJ/m² | 7.8 | 7.2 | 5.8 | 4.9 |
| Charpy at −20° C. | kJ/m² | 5.2 | 4.6 | 3.6 | 3.6 |
| Flexural Modulus | MPa | 900 | 930 | 980 | 990 |

1. A polymer composition comprising:
A) from 88% to 99% by weight of an ethylene polymer having MIP of equal to or higher than 5 g/10 min., where MIP is the melt flow index at 190° C. with a load of 5 kg, determined according to 1133-2:2011; and
B) from 1% to 12% by weight of a butene-1 polymer having MIE of equal to or higher than 800 g/10 min., where MIE is the melt flow index at 190° C. with a load of 2.16 kg, determined according to 1133-2:2011;
wherein the amounts of A) and B) are referred to the total weight of A)+B).

2. The composition according to claim 1, wherein the butene-1 polymer B) has a Brookfield viscosity at 190° C. from 1500 to 20000 mPa·sec.

3. The composition according to claim 1, wherein the butene-1 polymer B) is selected from the group consisting of butene-1 homopolymers, copolymers of butene-1 containing alpha-olefin comonomers different from butene-1, and mixtures thereof.

4. The composition according to claim 3, wherein the butene-1 polymer B) has a copolymerized comonomer content of from 0.5% to 4.0% by mole.

5. The composition according to claim 1, wherein the butene-1 polymer B) has an additional feature selected from the group consisting of:
a) a molecular weight distribution (Mw/Mn) lower than 4;
b) a melting point (TmII) lower than 110° C.;
c) a melting point (TmII) higher than 80° C.;
d) a glass transition temperature (Tg) in the range from −40° C. to −10° C.;
e) isotactic pentads (mmmm) measured with ¹³C-NMR operating at 150.91 MHz higher than 90%;
f) 4.1 insertions not detectable using a ¹³C-NMR operating at 150.91 MHz; and
g) X-ray crystallinity of from 25 to 65%.

6. The composition according to claim 1, wherein the ethylene polymer A) has a density from 0.930 to 0.970 g/cm³, measured according to ISO 1183-1:2012 at 23° C.

7. The composition according to claim 1, wherein the ethylene polymer A) has an additional feature selected from the group consisting of:
a MIF value from 50 to 200 g/10 min., where MIF is the melt flow index at 190° C. with a load of 21.60 kg, determined according to ISO 1133-2:2011;
a MIE value from 1 to 10 g/10 min.;
a ratio MIF/MIP of equal to or higher than 5; and
a ratio MIF/MIE of equal to or higher than 20.

8. An article of manufacture comprising the polyolefin composition of claim 1.

9. The article of manufacture according to claim 8, wherein the article is an injection-molded article or an extruded article.
